(19) United States
(12) Patent Application Publication
(10) Pub. No.: US 2015/0210509 A1
(43) Pub. Date: Jul. 30, 2015

(54) ELEVATOR AND METHOD FOR MODERNIZING AN ELEVATOR

(71) Applicant: KONE Corporation, Helsinki (FI)

(72) Inventor: Tapani TALONEN, Tervakoski (FI)

(73) Assignee: KONE CORPORATION, Helsinki (FI)

(21) Appl. No.: 14/679,624

(22) Filed: Apr. 6, 2015

Related U.S. Application Data
(63) Continuation of application No. PCT/FI2013/051023, filed on Oct. 30, 2013.

(30) Foreign Application Priority Data
Oct. 31, 2012 (FI) 20126134

(51) Int. Cl. B66B 11/00; B66B 7/06; B66B 19/02; B66B 9/00; B66B 19/00

(52) U.S. Cl. CPC B66B 11/008; B66B 9/00; B66B 19/007; B66B 19/02; B66B 19/005; B66B 7/06; B66B 11/004; B66B 11/009

(57) ABSTRACT

An elevator, more particularly an elevator for passenger transport and/or freight transport, which elevator includes an elevator car, is arranged to travel in an elevator hoistway. Above the elevator hoistway is a space bounded by a floor, a counterweight, a first suspension roping and a second suspension roping, which suspension ropings connect the aforementioned elevator car and counterweight to each other, a mechanism configured to move the first suspension roping and the second suspension roping, one or more diverting pulleys of the first suspension roping disposed in said space, one or more diverting pulleys of the second suspension roping disposed in said space, and in which elevator the first suspension roping and the second suspension roping travel on vertical planes parallel to each other. The first suspension roping forms a loop around one or more diverting pulleys of the first suspension roping, the second suspension roping forms a loop around one or more diverting pulleys of the second suspension roping, said loops are nested and the diverting pulley of the outer loop is disposed outside the inner loop, and the suspension ropings pass through the apertures in the aforementioned floor. A method for modernizing an elevator is also disclosed.

### FIELD OF THE INVENTION

The object of the invention is an elevator as defined in the preamble of claim 1, and a method as defined in the preamble of claim 10 for modernizing an elevator, which elevator is preferably an elevator applicable to passenger transport and/or to freight transport.

### BACKGROUND OF THE INVENTION

An elevator car moving in an elevator hoistway is supported and moved during operation supported by suspension roping, which roping is moved directly or indirectly with a hoisting machine. The hoisting machine is usually supported on the floor of a separate room area on top of the elevator hoistway, in a so-called machine room. Typically, a hoisting machine in a machine room comprises a rope traction sheave, over which the ropes of the roping are led, and a motor that rotates the rope traction sheave for moving the elevator car and the counterweight by means of the roping. This kind of an elevator is a very common elevator type.

Known in the art is a method for modernizing an elevator provided with a machine room into a toothed-belt driven elevator, in which the new hoisting machine is disposed in the top part of the elevator hoistway. In this method, the old hoisting machine is removed from the machine room, the ropes are detached from the elevator car and from the counterweight and removed. In the method known in the art a new hoisting machine is arranged in the top part of the elevator hoistway, which hoisting machine comprises a toothed-belt traction sheave, over which a toothed belt is led and fixed at its one end to the old elevator car and at its other end to the old counterweight.

When modernizing old rope elevators to become belt-driven, which elevators will require a number of belts with prior-art belt applications and the width of which belts is greater than the thickness of the old ropes of circular cross-sectional shape, in particular the following problems occur. The drop projection of the old ropes prior to modernization is not as wide as the drop projection of the belts after the modernization. Owing to this, the size of the lead-in apertures of the floor between the machine room and the elevator hoistway should be increased, which is often laborious, expensive, and difficult without weakening the structural strength properties of the load-bearing floor. In addition, on top of the elevator car and counterweight there is limited space for fixing the ropes. Compatibility problems occur, in particular, when the counterweight is on the side of the elevator car. In this case, the belts need to be turned and they require more space horizontally than there is space reserved for the counterweight. According to prior art, a 1:1 suspension ratio is changed to a 1:2 suspension ratio, the size of the lead-in apertures of the floor leading from the machine room into the elevator hoistway is increased, and/or the layout for large elevators is designed without a counterweight being disposed on the side of the elevator car.

Both the increase of the size of the lead-in apertures between the machine room and the elevator hoistway and the changing of the suspension ratio from 1:1 to 1:2 are expensive in terms of costs and require considerable installation times. It is not always possible to increase the size of the lead-in apertures, owing to load-bearing steel structures, in connection with an elevator hoistway. In connection with modernization, it is not necessarily possible to select a wide drop line for belts to fit the elevator layout. In many cases it is not possible to fabricate large elevators without a counterweight being disposed on the side.

### BRIEF DESCRIPTION OF THE INVENTION

The aim of the invention is to solve the aforementioned problems of prior art solutions as well as the problems disclosed in the description of the invention below. The aim is thus to provide a method for modernizing an elevator without breaking the floor structure above the elevator hoistway and an elevator, the movement of the elevator car of which can be brought about efficiently and without problems, when the elevator is arranged to travel in an elevator hoistway, above which elevator hoistway is a space bounded by a floor.

With the solution according to the invention an elevator is achieved, the motor of which is smaller in size and cheaper in terms of costs compared to earlier. Thus the size of the whole hoisting machine is smaller and modernization and installation of the hoisting machine more affordable in terms of costs. With the solution according to the invention a better elevator in terms of safety is also achieved.

With the solution according to the invention, inter alia, the performance of installation by a fitter can be facilitated. Disclosed are, inter alia embodiments with which it is possible to implement the same method at installation sites that vary greatly from each other. Disclosed are, inter alia, embodiments with which it is possible to modernize quickly and efficiently an old rope elevator to become belt driven. Disclosed are, inter alia, embodiments with which it is possible to implement modernization without increasing the size of the lead-in apertures of the roping of the floor between the space above the elevator hoistway, such as the old machine room, and the elevator hoistway and without breaking the floor structures. Disclosed are, inter alia, embodiments with which it is possible to implement modernization of an elevator without changing the 1:1 suspension ratio. Disclosed are, inter alia, embodiments with which it is possible to implement modernization of an elevator without changing the elevator layout and to configure the drop projection of the new roping on a case-by-case basis to be suitable for the location of the lead-in apertures of the floor of the space above the elevator hoistway. Disclosed are, inter alia, embodiments with which it is possible to implement the installation of the elevator roping efficiently in connection with modernization.

The invention is based on the concept of arranging the elevator roping to be such that the drop projection of the belts of the suspension roping is brought about to be compact by means of first suspension roping and second suspension roping, which suspension ropings connect the aforementioned elevator car and aforementioned counterweight to each other, preferably with a 1:1 suspension, and travel on vertical planes parallel to each other. Preferably the first suspension roping and the second suspension roping are fixed at their first end to the elevator car and at their second end to the counterweight. In the space above the elevator hoistway is arranged one or more diverting pulleys of the first suspension roping and one or more diverting pulleys of the second suspension roping. The first suspension roping forms a loop around one or more diverting pulleys of the first suspension roping and the second suspension roping forms a loop around one or more diverting pulleys of the second suspension roping. The aforementioned loops are nested and the diverting pulley of the outer loop is disposed outside the inner loop, and both suspension ropings pass through the lead-in apertures in the aforementioned floor.

In this way the structure of the suspension ropings of an elevator and the number of belt-like ropes or belts can be optimized from the viewpoint of the supporting capability of the elevator car and of the counterweight and the longitudinal loading of the suspension roping between them, and the drop projection can be configured on a case-by-case basis to be suitable for the location of the lead-in apertures of the floor of the space above the elevator hoistway.

In addition, the elevator comprises means for exerting a vertical force on the elevator car or on the counterweight, which means for exerting vertical force on the elevator car or on the counterweight preferably comprise a hosting machine of the first suspension roping and of the second suspension roping, which hoisting machine is preferably disposed in the aforementioned space situated above the elevator hoistway and comprises means for moving the first suspension roping and the second suspension roping. The means for moving the first suspension roping and the second suspension roping comprise one or more rotating devices, such as a motor, and at least two rotatable traction means, such as traction sheaves, at least one for each suspension roping separately. In this case the power transmission and gearbox can be made simply, e.g. using the most common power transmission solutions for an elevator, such as a belt gear.

Preferably the suspension ropings are connected to the elevator car and to the counterweight in such a way that when the elevator car moves up the counterweight moves down, and vice versa, and the suspension ropings travel via the diverting pulleys disposed in the space above the elevator hoistway. Preferably one of the diverting pulleys of each suspension roping is a driven diverting pulley, such as a traction sheave, which acts directly on the suspension roping.

In one preferred embodiment the hoisting machine comprises two separate motors, which are connected coaxially directly or via a shaft gear to two separate traction sheaves for moving the first and second suspension roping. In this way an individual motor can be made smaller in size and cheaper in terms of its costs compared to earlier.

In one preferred embodiment the means for moving the first suspension roping and the second suspension roping comprise a hoisting machine, which hoisting machine is arranged to move both suspension ropings and comprises a motor common to both suspension ropings.

In one preferred embodiment the hoisting machine comprises one motor common to a first and second traction sheave, which traction sheaves are in connection with the motor via a belt gear common to both traction sheaves for moving the first and second suspension roping. Thus the size of the hoisting machine can be made smaller and modernization and installation of the hoisting machine cheaper in terms of costs.

In one preferred embodiment the hoisting machine comprises one motor common to the first and second traction sheave, which traction sheaves are in connection with the motor via a belt gear separate to each traction sheave for moving the first and second suspension roping. In this way a better elevator in terms of safety is achieved.

In one preferred embodiment the aforementioned means for exerting a vertical force on the elevator car or on the counterweight comprise traction roping, which is connected to both the elevator car and the counterweight, and a hoisting machine that is situated in the proximity of the bottom end of the path of movement of the elevator car. In this case the hoisting machine comprises means for moving said traction roping, which means preferably comprise a rotating device, such as a motor, and a rotatable traction means, such as a traction sheave. In this case, there is no hoisting machine disposed in the aforementioned space that is bounded by a floor and is above the elevator hoistway. The suspension of the elevator can in this case be based on rope suspension, e.g. using a belt-like rope, and the traction roping can be optimized in terms of tensile properties.

Preferably the traction roping rotates below the traction means of the hoisting machine. Preferably the traction roping is suspended to hang at its first end from the elevator car and at its second end from the counterweight.

Preferably the first and second suspension roping and/or traction roping comprise(s) one or more toothed belts. In a toothed-belt driven elevator the toothing of the toothed belt is in positively-driven traction contact with the toothing of the traction sheave forming a non-slip traction, which is mainly based on shape-locking. With such a positive-drive type of elevator, which is balanced for a zero load, the weight of the elevator car can be minimized, because there is no need to ensure adequate friction, and the magnitude of the counterweight can be minimized. The moving masses and the average imbalance can be optimized as advantageously as possible and low energy consumption is achieved.

Preferably a toothed belt is selected as the toothed belt, the tooth direction of which is essentially perpendicular with respect to the longitudinal direction of the toothed belt, even more preferably a tractor-tire patterned toothed belt.

Preferably a toothed belt formed from rubber or polyurethane is selected as the toothed belt, inside which is a plurality of longitudinal load-bearing suspension means for receiving a tensile load exerted on the toothed belt.

In one preferred embodiment the aforementioned suspension means are cables or ropes, such as steel cables or fiber cables, or combinations of these. The belt-like rope can in this case be any commercially available rope or toothed belt. The suspension can thus be arranged inexpensively and to be durable.

In one preferred embodiment the suspension roping comprises one or more belt-like ropes, which comprise a load-bearing composite part, which comprises reinforcing fibers, e.g. carbon fiber reinforcements, glass fiber reinforcements, or Aramid fiber reinforcements, preferably parallel fiber reinforcements in a polymer matrix. In this way compactly strong and lightweight suspension roping of an elevator is achieved.

In one preferred embodiment the suspension roping comprises one or more belt-like ropes, which comprise a power transmission part or power transmission parts, which is a braid/which are braids. The rope of the suspension roping can thus be formed inexpensively with conventional technology and with a small radius in a bendable manner. The braid can comprise metal fibers or, for example, Aramid fibers. The rope can thus be a belt, inside which there are one or more steel braids or, for example, Aramid fiber braids.

In one preferred embodiment the aforementioned first suspension roping and second suspension roping each comprise one or more belt-like ropes or belts, which said belt-like ropes or belts travel nested on the same plane.

In one preferred embodiment the suspension roping comprises at least two ropes essentially belt-like in their cross-section. Preferably the width/thickness of the rope is at least 2 or more, preferably at least 4, even more preferably at least 5 or more, even more preferably at least 6, even more preferably at least 7 or more, even more preferably at least 8 or more, possibly more than 10. In this way good power transmission capability is achieved with a small bending radius.

In one preferred embodiment upward racing of the elevator car and/or of the counterweight is prevented in a fault situation. Racing of the elevator car and/or of the counterweight is prevented by measuring the force exerted on the belt by the elevator car and/or by the counterweight with a LWD sensor or with a separate switch installed on the belt. If the aforementioned sensor or switch detects a change in the force exerted on the belt by the elevator car and/or by the counterweight as a consequence of deviating acceleration, the traction sheaves are stopped and racing is prevented.

In the method according to the invention for modernizing an elevator the old suspension roping and hoisting machine are removed from the elevator, and a new hoisting machine is disposed in a space above the elevator hoistway, such as e.g. in the old machine room, and the first suspension roping and the second suspension roping are arranged to travel on vertical planes parallel to each other and the first suspension roping to form a loop around one or more diverting pulleys of the first suspension roping, and the second suspension roping to form a loop around one or more diverting pulleys of the second suspension roping in such a way that the aforementioned loops are nested, and the diverting pulley of the outer loop is disposed outside the inner loop. In addition, both suspension ropings are arranged to pass through the lead-in apertures of the suspension ropings, said apertures being in the floor between the space above the elevator hoistway and the elevator hoistway. Thus the elevator car and the counterweight are moved with the hoisting machine by exerting a vertical tractive force on the elevator car or on the counterweight via the first and second suspension roping, thus acting on the force imbalance between them, thereby controlling their movement.

Preferably the aforementioned first suspension roping and second suspension roping are arranged to each comprise one or more belts or belt-like ropes.

In one preferred embodiment of the method according to the invention the old suspension roping and hoisting machine are removed, and a new hoisting machine is placed in the proximity of the bottom end of the path of movement of the elevator car, and the first suspension roping and the second suspension roping are arranged to travel on vertical planes parallel to each other and the first suspension roping to form a loop around one or more diverting pulleys of the first suspension roping, the second suspension roping to form a loop around one or more diverting pulleys of the second suspension roping in such a way that the aforementioned loops are nested, and the diverting pulley of the outer loop is disposed outside the inner loop. In addition, both suspension ropings are arranged to pass through the lead-in apertures of the roping, said apertures being in the floor between the elevator hoistway and the space above the elevator hoistway. In addition, means are arranged to comprise traction roping, which is connected to the elevator car and to the counterweight for exerting a vertical force on said elevator car or counterweight. In addition, a hoisting machine is arranged to comprise means for moving the traction roping, which means preferably comprise a rotating device, such as a motor, and a rotatable traction means, such as a traction sheave. Thus the elevator car and the counterweight are moved with the hoisting machine by exerting a vertical tractive force on the elevator car or on the counterweight via traction roping, thus acting on the force imbalance between them, thereby controlling their movement.

Preferably the aforementioned traction roping is arranged to comprise one or more belts or belt-like ropes.

Preferably, when modernizing an old elevator the size of the old suspension roping lead-in apertures of the floor between the space above the elevator hoistway, such as the old machine room, and the elevator hoistway is not altered.

Preferably an elevator implemented with the method according to the invention comprises at least two traction sheaves, preferably in the proximity of the top end of the path of movement of the elevator car, supported on which traction sheaves the belts of the first and second suspension roping support the elevator car and counterweight, preferably with a 1:1 suspension.

Preferably the mass of the counterweight of the elevator that is modernized to be toothed-belt driven and zero balanced is increased in such a way that new balancing is achieved for the average load of the elevator car. An average load refers to an elevator car load, which corresponds to a load of approximately 1-3 people. Preferably a zero balanced elevator can be driven at a higher speed than an elevator provided with a counterweight dimensioned according to prior art. A further advantage is that, because there is less weight, fewer parts are required and the manufacturing costs, installation costs and maintenance costs are low.

The solution according to the invention is particularly suitable for modernization wherein an old rope-driven elevator needs to be converted into a belt-driven elevator. Since converting a rope-driven elevator into a belt-driven one would require increasing the size of the lead-in apertures of the floor between the old machine room and the elevator hoistway, the increase in the size of the lead-in apertures of the floor can be prevented by changing at the same time the suspension of the elevator to be such that the drop projection of the belts of the first and second suspension roping fits through the lead-in apertures of the floor of the old suspension roping at least when using two separate traction sheaves. The solution according to the invention, however, does not need to be used only in connection with modernization, but instead the elevator according to the invention is just as well suited as a newly installed elevator.

The elevator is most preferably an elevator applicable to passenger transport and/or freight transport, which elevator is installed in a building, to travel in a vertical direction or at least in an essentially vertical direction, preferably on the basis of landing calls and/or car calls. The elevator car has preferably an interior space, which is most preferably suitable to receive one passenger or a plurality of passengers. The elevator preferably comprises at least two, preferably more, floor levels to be served.

Some inventive embodiments are also presented in the descriptive section and in the drawings of the present application. The inventive content of the application can also be defined differently than what is done in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments of the invention can be applied within the framework of the basic inventive concept in conjunction with other embodiments.

### BRIEF DESCRIPTION OF THE FIGURES

The invention is now described in more detail in conjunction with preferred embodiments with reference to the attached drawings, in which

FIG. 1 presents a preferred embodiment of an elevator according to the invention.

FIG. 2 presents a second preferred embodiment of an elevator according to the invention.

FIG. 3 presents a) a side view b) a top view c) a drop projection of a preferred embodiment of a suspension arrangement of an elevator according to the invention.

FIG. 4 presents a) a side view b) a top view c) a drop projection of a second preferred embodiment of a suspension arrangement of an elevator according to the invention.

FIG. 5 presents a top view of a drop projection of a third preferred embodiment of a suspension arrangement of an elevator according to the invention.

### DETAILED DESCRIPTION OF THE INVENTION

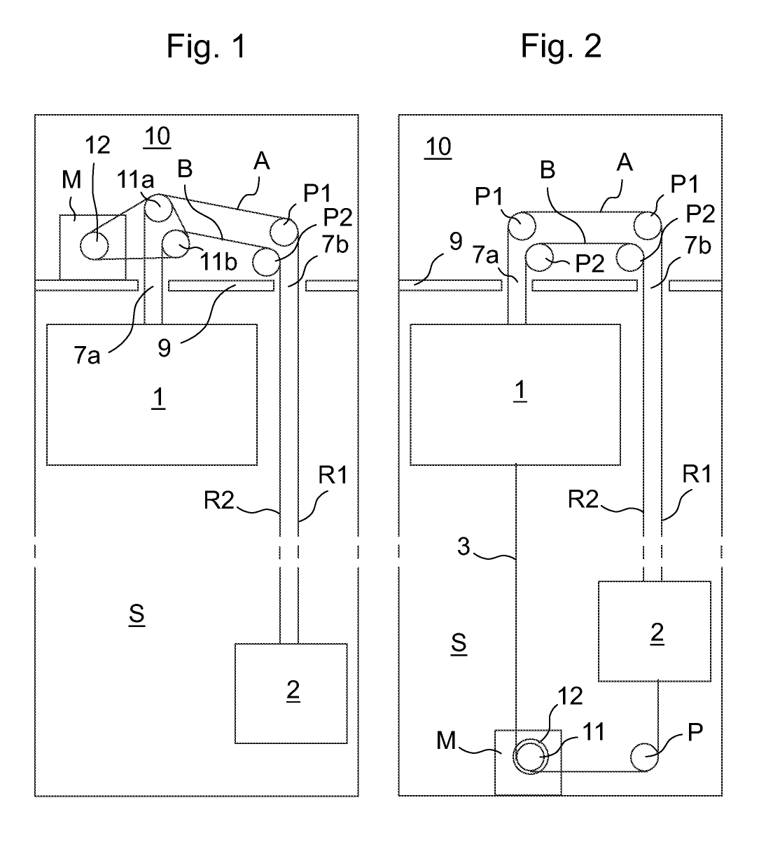

FIG. 1 presents one embodiment of an elevator according to the invention wherein an elevator suspension implemented with a belt-geared hoisting machine M is utilized. The roping of the elevator is arranged to be such that the drop projection of the belts of the suspension ropings R1 and R2 is achieved to be compact by means of the first suspension roping R1 and the second suspension roping R2, which suspension ropings R1, R2 connect the aforementioned elevator car 1 and counterweight 2 to each other with a 1:1 suspension, and travel on vertical planes parallel to each other. The first suspension roping R1 and the second suspension roping R2 are fixed at their first end to the elevator car 1 and at their second end to the counterweight 2. Into the space 10 above the elevator hoistway is arranged a diverting pulley P1 of the first suspension roping R1 and a diverting pulley P2 of the second suspension roping R2. The first suspension roping R1 forms a loop A around the diverting pulley P1 of the first suspension roping, and the second suspension roping R2 forms a loop B around the diverting pulley P2 of the second suspension roping R2. The aforementioned loops A, B are nested and the diverting pulley P1 of the outer loop A is disposed outside the inner loop B, and both suspension ropings R1, R2 pass through the lead-in apertures 7a, 7b in the aforementioned floor 9.

Thus the structure of the suspension ropings R1, R2 of the elevator and the number of belt-like ropes or belts is optimized from the viewpoint of the supporting capability of the elevator car 1 and of the counterweight 2 and the longitudinal loading of the suspension ropings R1, R2 between them, and the drop projection is configured to be suitable for the location of the lead-in apertures 7a, 7b of the floor 9 of the space 10 above the elevator hoistway S.

In addition, the elevator comprises means for exerting vertical force on the elevator car 1 or on the counterweight 2, which means for exerting vertical force on the elevator car 1 or on the counterweight 2 comprise, in addition to the first suspension roping R1 and the second suspension roping R2, a hoisting machine M, which is disposed in the aforementioned space 10 situated above the elevator hoistway S and comprises means for moving the first suspension roping R1 and the second suspension roping R2. The means for moving the first suspension roping R1 and the second suspension roping R2 comprise one or more rotating devices, such as a motor 12, and at least two rotatable traction means, such as a traction sheave 11a, 11b, for each suspension roping R1, R2 separately. The power transmission and gearing can thus be made simply, for example, using a belt gear 11a, 11b, 12, 13 common to both traction sheaves 11a, 11b.

The suspension ropings R1 and R2 are connected to the elevator car 1 and to the counterweight 2 in such a way that when the elevator car 1 moves up, the counterweight 2 moves down, and vice versa, and the suspension ropings R1 and R2 travel via diverting pulleys P1 and P2 disposed in the space above the elevator hoistway S and via traction sheaves 11a and 11b, which traction sheaves 11a and 11b act directly on the suspension ropings R1 and R2.

The hoisting machine M comprises one motor 12 common to the traction sheave 11a of the first suspension roping R1 and to the traction sheave 11b of the second suspension roping R2, which traction sheaves 11a and 11b are in connection with the motor 12 via a belt gear 11a, 11b, 12, 13 that is common to both traction sheaves 11a and 11b for moving the first suspension roping R1 and the second suspension roping R2. Thus the size of the hoisting machine M is made smaller and modernization and installation of the hoisting machine cheaper in terms of costs.

In one preferred embodiment the hoisting machine M comprises two separate motors, which are connected coaxially directly or via a shaft gear to two separate traction sheaves 11a for moving the first suspension roping R1 and 11b for moving the second suspension roping R2. In this way an individual motor is made smaller in size and cheaper in terms of its costs compared to earlier.

In a third preferred embodiment the hoisting machine M comprises one motor 12 common to the first traction sheave 11a, for moving the first suspension roping R1, and to the second traction sheave 11b, for moving the second suspension roping R2. The aforementioned traction sheaves 11a and 11b are in connection with the motor 12 via their own belt gears separate for each traction sheave 11a and 11b. Thus a better elevator in terms of safety is achieved.

FIG. 2 presents a second embodiment of the elevator according to the invention, in which the hoisting machine M is disposed in the proximity of the bottom end of the path of movement of the elevator car 1. The hoisting machine M of the elevator is arranged in the bottom part of the elevator hoistway S and the first suspension roping R1 and the second suspension roping R2 are arranged to travel on vertical planes parallel to each other and the first suspension roping R1 to form a loop A around one or more, preferably at least two, diverting pulleys P1 of the first suspension roping R1, the second suspension roping R2 to form a loop B, around one or more, preferably at least two, diverting pulleys P2 of the second suspension roping R2, in such a way that said loops A and B are nested, and the diverting pulleys P1 of the outer loop A are disposed outside of the inner loop B. In addition, both suspension ropings R1 and R2 are arranged to pass through the lead-in apertures 7a and 7b of the roping, said apertures being in the floor 9 between the elevator hoistway S and the space 10 above the elevator hoistway. In addition, the elevator is arranged to comprise traction roping 3, which is connected to the elevator car 1 and to the counterweight 2 for exerting a vertical force on said elevator car 1 or counterweight 2. In addition, a diverting pulley P and a hoisting machine M are arranged in the proximity of the bottom end of the path of movement of the elevator car 1 to comprise means for moving the traction roping 3, which means comprise a rotating device, such as a motor 12, and a rotatable traction means, such as a traction sheave 11. Thus the elevator car 1 and the counterweight 2 are moved with the hoisting machine M by exerting a vertical tractive force on the elevator car 1 or on the counterweight 2 via the traction roping 3, thus acting on the force imbalance between them, thereby controlling their movement. The aforementioned traction roping 3 preferably comprises one or more belt-like ropes or belts, such as a toothed belt.

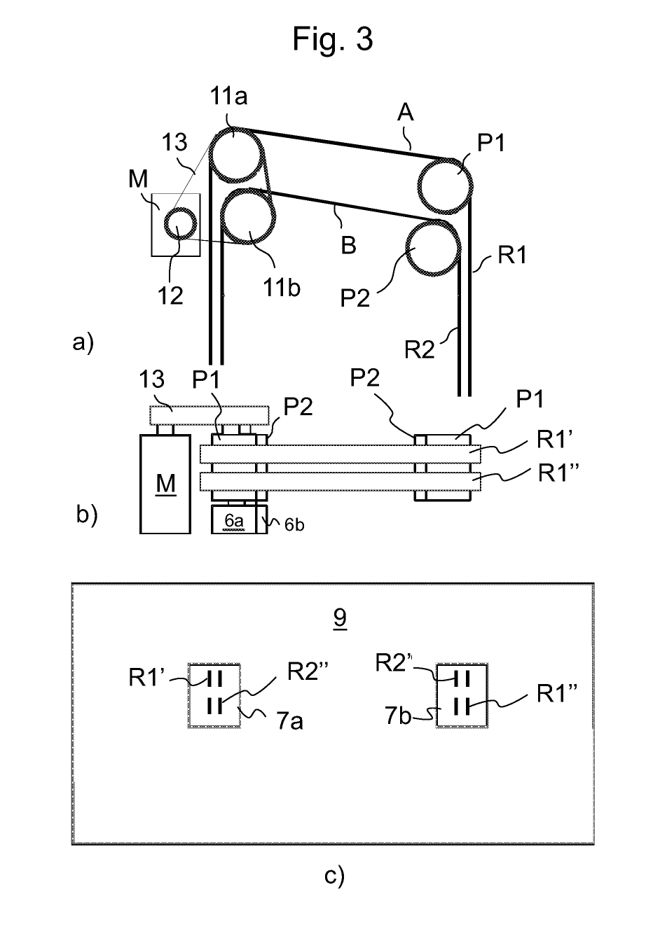

FIG. 3a presents a side view of one preferred embodiment of a suspension arrangement of an elevator according to the invention, FIG. 3b presents a top view of the suspension arrangement of FIG. 3a, and FIG. 3c a drop projection of the suspension ropings R1, R2 of FIG. 3a. In the elevator an elevator suspension implemented with a belt-geared 11a, 11b, 12, 13 hoisting machine M is utilized. The roping of the elevator is arranged to be such that the suspension roping R1 comprises two parallel belt-like ropes or belts R1′ and R1″ and the suspension roping R2 two parallel belt-like ropes or belts R2′ and R2″. The drop projection of the belts R1′, R1″, R2′ and R2″ is achieved to be compact by means of two nested suspension ropings, the suspension roping R1 and the suspension roping R2, which suspension ropings R1, R2 connect the aforementioned elevator car 1 and counterweight 2 to each other with a 1:1 suspension, and travel on vertical planes parallel to each other. The first suspension roping R1 and the second suspension roping R2 are fixed at their first end to the elevator car 1 and at their second end to the counterweight 2. In the space 10 above the elevator hoistway is arranged a diverting pulley P1 of the first suspension roping R1 and a diverting pulley P2 of the second suspension roping R2. The first suspension roping R1 forms a loop A around one or more diverting pulleys P1 of the first suspension roping and the second suspension roping R2 forms a loop B around one or more diverting pulleys P2 of the second suspension roping. R2. The aforementioned loops A, B are nested and the diverting pulley P1 of the outer loop A is disposed outside the inner loop B, and both suspension ropings R1, R2 pass through the lead-in apertures 7a, 7b in the aforementioned floor 9. Thus the structure of the suspension ropings R1, R2 of the elevator and the number of belt-like ropes or belts R1′, R1″, R2′ and R2″ is optimized from the viewpoint of the supporting capability of the elevator car 1 and the counterweight 2 and from the viewpoint of the longitudinal loading of the suspension ropings R1, R2 between them, and the drop projection presented in FIG. 3c is configured to be suitable for the location of the lead-in apertures 7a, 7b of the floor 9 of the space 10 above the elevator hoistway S without breaking the floor structures. A machine brake 6a, 6b is arranged in connection with the traction sheave 11a, 11b to brake the traction sheave 11a, 11b without any gearing.

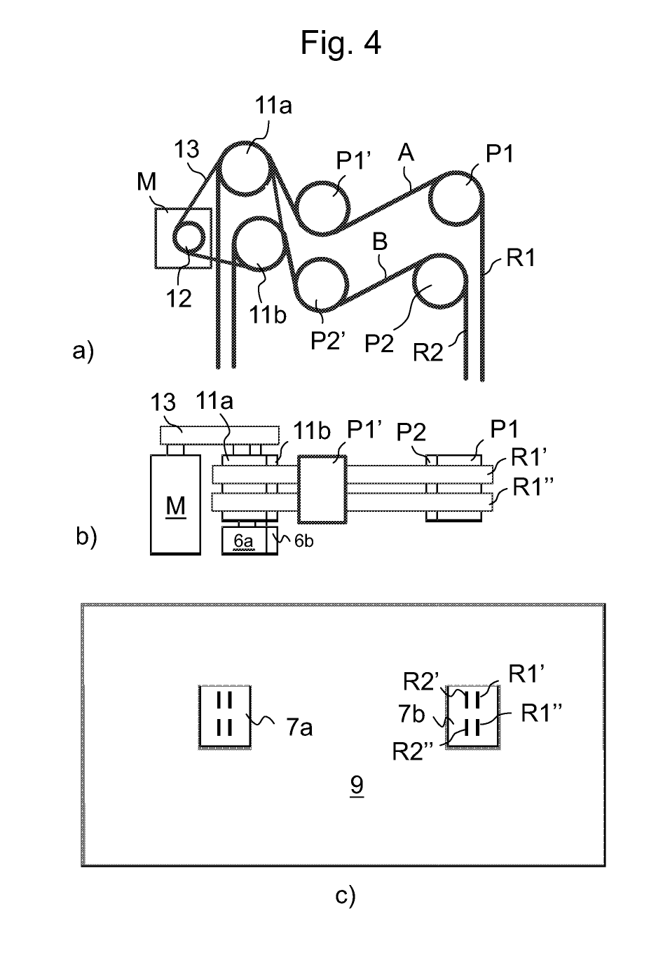

FIG. 4a presents a side view of a second preferred embodiment of a suspension arrangement of an elevator according to the invention, FIG. 4b presents a top view of the suspension arrangement of FIG. 4a, and FIG. 4c a drop projection of the suspension ropings R1, R2 of FIG. 4a. In the elevator according to FIGS. 4a-4c, an elevator suspension implemented with a belt-geared 11a, 11b, 12, 13 hoisting machine M is utilized. The roping of the elevator is arranged to be such that the suspension roping R1 comprises two parallel belt-like ropes or belts R1′ and R1′ and the suspension roping R2 two parallel belt-like ropes or belts R2′ and R2″. The drop projection of the belts R1′, R1″, R2′ and R2″ is achieved to be compact by means of two nested suspension ropings R1, R2, which suspension ropings R1, R2 connect the aforementioned elevator car 1 and counterweight 2 to each other with a 1:1 suspension, and travel on vertical planes parallel to each other. The first suspension roping R1 and the second suspension roping R2 are fixed at their first end to the elevator car 1 and at their second end to the counterweight 2. In the space 10 above the elevator hoistway is arranged at least two diverting pulleys P1, P1′ of the first suspension roping R1 and at least two diverting pulleys P2, P2′ of the second suspension roping R2. The first suspension roping R1 forms a loop A around at least two diverting pulleys P1, P1′ of the first suspension roping, and the second suspension roping

R2 forms a loop B around at least two diverting pulleys P2, P2′ of the second suspension roping R2. The aforementioned loops A, B are nested and the diverting pulleys P1, P1′ of the outer loop A are disposed outside the inner loop B, and both suspension ropings R1, R2 pass through the lead-in apertures 7a, 7b in the aforementioned floor 9. The diverting pulleys P1′, P2′ are essentially of the same size as the traction sheave 11a of the suspension roping R1 and as the traction sheave 11b of the suspension roping R2. In the suspension arrangement according to FIGS. 4a-4c the suspension roping R1, R2, passes around the traction sheave 11a, 11b once, in which case the contact angle of the rope is approximately 180° on the traction sheave, in which case the diverting pulley P1′, P2′ is used as an aid for the “touching” of the belt-like rope or belt R1, R1″, R2′ and R2″ and the diverting pulleys P1′, P2′ function as rope guides and as damping pulleys for damping vibrations. By increasing the contact angle of the traction sheave 11a, 11b by means of the rope pulley P1′, P2′, which functions as a diverting pulley, the grip can be increased between the traction sheave 11a, 11b and the suspension roping R1, R2. In this way the car can be made lighter and also smaller in size, in which case the space-saving potential of the elevator increases. Thus also a sufficient grip, from the viewpoint of the operation and safety of the elevator, is ensured between the belt-like rope or belt R1, R1″, R2′, R2″ and the traction sheave 11a, 11b. A machinery brake 6a, 6b is arranged in connection with the traction sheave 11a, 11b to brake the traction sheave 11a, 11b without gearing.

In one embodiment of the invention the support beam system of the diverting pulleys P1, P2, P1′, P2′ disposed in the space above the elevator hoistway S comprises a plurality of consecutive fastening holes for adjusting the horizontal distance between the traction sheaves 11a, 11b, and diverting pulleys P1, P2, P1′, P2′. Thus the contact angle of the traction sheaves 11a, 11b can be adjusted to be suitable by adjusting the horizontal distance between the traction sheaves 11a, 11b, and diverting pulleys P1, P2, P1′, P2′, in which case optimal grip between the traction sheave 11a, 11b, and suspension roping R1, R2 is achieved.

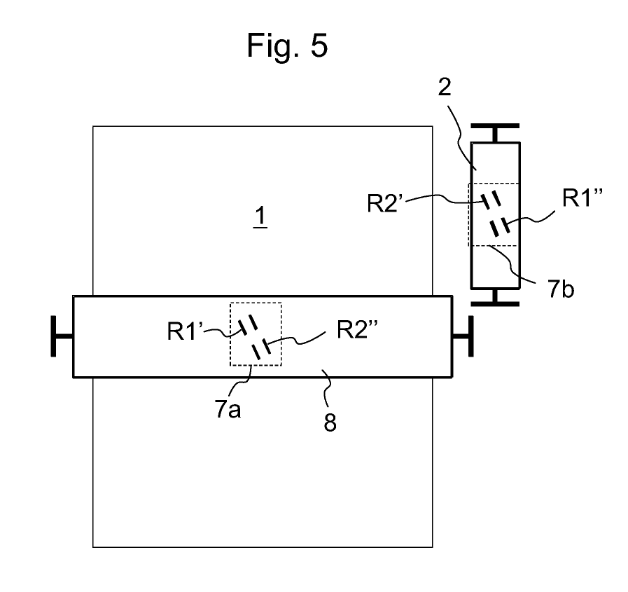

FIG. 5 presents a top view of a preferred drop projection of the suspension roping of an elevator according to the invention, when the counterweight 2 is disposed on the side of an elevator car 1. FIG. 5, being simplified, shows nothing of the car sling other than a part of an essentially horizontal top beam 8 with its guide rails. A counterweight 2 with its guide rails is arranged to the side of the elevator car 1. In addition, the lead-in apertures 7a, 7b of the floor 9 between the space 10 above the elevator hoistway and the elevator hoistway S are presented with a dotted line, said apertures being for the suspension ropings R1 and R2. As seen in FIG. 5, the elevator requires according to the figure four belt-like ropes or belts R1, R1″, R2′ and R2″, the width of which belts R1, R1″, R2′ and R2″ is greater than the thickness of the old ropes of circular cross-sectional shape. In the situation according to FIG. 5 there is limited space on top of the elevator car 1 and counterweight 2 for the fixing of the belt-like ropes or belts. Compatibility problems occur in particular in the cases of FIG. 5 when the counterweight 2 is on the side of the elevator car 1. In this case, the belt-like ropes or belts R1, R1″, R2′ and R2″ need to be turned and they require more space horizontally than there is available space reserved for the counterweight 2.

In connection with the modernization of an old geared elevator suspended 1:1, the elevator suspension arrangement is implemented in the method according to the invention e.g. in such a way that the old geared hoisting machine is removed from the old machine room above the elevator hoistway, in which hoisting machine the rotational speed ratio of the machine and the traction sheave is converted by means of a gear, with the traction sheave(s) of said machine and also possibly the diverting pulley that determines the maximum horizontal distance of the suspension roping in the lateral direction, i.e. the so-called L dimension. After this, a new geared hoisting machine comprising driven traction sheaves 11a, 11b is disposed in the machine room at a suitable height and also in a suitable location in the lateral direction. In addition, at least two diverting pulleys P1, P2 are disposed in the machine room in such a way that the suspension roping R1 forms a loop A around the diverting pulley P1 of at least the first suspension roping R1, and the second suspension roping R2 forms a loop B around the diverting pulley P2 of at least the second suspension roping R2.

It is obvious to the person skilled in the art that the invention is not limited solely to the example described above, but that it may be varied within the scope of the claims presented below. Thus, for example, the number and position of diverting pulleys in the space S above the elevator hoistway may vary from what is presented above. In addition, there can be more than two, preferably three, even more preferably four parallel belt-like ropes or belts per suspension roping.

In one embodiment of the invention, the old hoisting machine is replaced by a new hoisting machine, which comprises a traction sheave rotated by an electric motor and a machinery brake, which is arranged to act on the traction sheave gearlessly. In this case, the brake is preferably arranged to act directly on the traction sheave or on a part that is in fixed connection with the traction sheave and rotates as the traction sheave rotates. In this case, the brake is preferably a friction-based brake which presses in the braking position against the traction sheave or against a part in fixed connection with the traction sheave, e.g. against a cylindrical part rotating coaxially with the traction sheave. In this way the problem of a geared hoisting machine, where the brake acts on the motor, is avoided. If the shaft between the machine and the gear is broken or the teeth of the gear break, the brake does not affect the traction sheave, which is able to rotate freely. In this case in an underload situation with counterweight the car would go upwards at an accelerating speed.

The advantage of the solution according to the invention is, inter alia, better energy economy, which will benefit both residents and housing corporations. Better energy economy is a result of the fact that by the aid of the solution according to the invention it is possible to better utilize new motor technology, drive technology and control technology when modernizing, in which case, e.g. wasted energy can be fed back into the electricity network. A further advantage of the solution is that the old car and car sling can be used in connection with modernization, so the old elevator components can be utilized in the new arrangement also. Another advantage is that elevator safety is improved in an embodiment wherein the machinery brake is arranged in connection with the traction sheave to brake the traction sheave without gearing. More particularly, situations of upward overspeeding of a car can be more securely prevented.

1. An elevator, comprising:
an elevator car, which is arranged to travel in an elevator hoistway, above which elevator hoistway is a space bounded by a floor;
a counterweight;
a first suspension roping and a second suspension roping, which suspension ropings connect the elevator car and counterweight to each other;
a mechanism configured to move the first suspension roping and the second suspension roping;
one or more diverting pulleys of the first suspension roping being disposed in said space; and
one or more diverting pulleys of the second suspension roping being disposed in said space,
wherein:
the first suspension roping and the second suspension roping travel on vertical planes parallel to each other;
the first suspension roping forms a loop around one or more diverting pulleys of the first suspension roping;
the second suspension roping forms a loop around one or more diverting pulleys of the second suspension roping;
the loops are nested and the diverting pulley of the outer loop is disposed outside the inner loop; and
the suspension ropings pass through the apertures in the floor.

2. The elevator according to claim 1, wherein the mechanism configured to move the first suspension roping and the second suspension roping comprises a hoisting machine, which hoisting machine is arranged to move both suspension ropings, and comprises a motor common to both suspension ropings.

3. The elevator according to claim 1, wherein the mechanism configured to move the first suspension roping and the second suspension roping comprises a hoisting machine that is disposed in the space above the elevator hoistway, which hoisting machine comprises one or more rotating devices, and at least two rotatable traction devices.

4. The elevator according to claim 1, wherein the mechanism configured to move the first suspension roping and the second suspension roping comprises a hoisting machine, which comprises one motor common to the traction sheave of the first suspension roping and to the traction sheave of the second suspension roping, which traction sheaves are in connection with said motor via a belt gear common to both traction sheaves.

5. The elevator according to claim 1 above, wherein the mechanism configured to move the first suspension roping and the second suspension roping comprises a hoisting machine, which comprises two separate motors, which are connected coaxially directly or via a shaft gear to two separate traction sheaves.

6. The elevator according to claim 1, wherein the mechanism configured to move the first suspension roping and the second suspension roping comprises a hoisting machine, which comprises one motor common to the first and second traction sheave, which traction sheaves are in connection with said motor via a belt gear separate to each traction sheave.

7. The elevator according to claim 1, wherein there is no hoisting machine disposed in the space that is bounded by a floor and above the elevator hoistway.

8. The elevator according to claim 1, wherein the first suspension roping and second suspension roping each comprise one or more belt-like ropes or belts.

9. The elevator according to claim 1, wherein the first suspension roping and second suspension roping each comprise one or more belt-like ropes or belts, which belt-like ropes or belts travel nested on the same plane.

10. The elevator according to claim 1, wherein the first suspension roping and second suspension roping are fixed at first ends thereof to the elevator car and at second ends thereof to the counterweight.

11. The elevator according to claim 1, wherein the mechanism configure to move the first suspension roping and the second suspension roping comprises traction roping separate from the suspension ropings, which traction roping is connected to the elevator car and to the counterweight, and a hoisting machine, which is disposed in the proximity of the bottom end of the path of movement of the elevator car, which hoisting machine comprises a mechanism configured to move the traction roping, comprising a rotating device and a rotatable traction device.

12. The elevator according to claim 8, wherein the traction roping comprises one or more belt-like ropes or belts.

13. A method for modernizing an elevator, which elevator comprises at least an elevator car, which is configured to be moved in the elevator hoistway, a counterweight, suspension roping, which is connected to the elevator car and to the counterweight, and a hoisting machine disposed in a space above the elevator hoistway, the space being bounded by a floor, and a diverting pulley, wherein the old suspension roping and hoisting machine are removed, and a new hoisting machine is disposed in the space above the elevator hoistway said method comprising the steps of
arranging the first suspension roping and the second suspension roping to travel on vertical planes parallel to each other;
arranging the first suspension roping to form a loop around one or more diverting pulleys of the first suspension roping;
arranging the second suspension roping to form a loop around one or more diverting pulleys of the second suspension roping in such a way that said loops are nested, and the diverting pulley of the outer loop is disposed outside the inner loop; and
arranging the suspension ropings to pass through the apertures in the floor.

14. The method according to claim 10, wherein the new hoisting machine comprises one motor common to the traction sheave of the first suspension roping and to the traction sheave of the second suspension roping, which traction sheaves are in connection with the motor via a belt gear common to both traction sheaves for moving the first suspension roping and the second suspension roping.

15. The method according to claim 10, wherein the aforementioned new hoisting machine comprises two separate motors, which are connected coaxially directly or via a shaft gear to two separate traction sheaves for moving the first suspension roping and the second suspension roping.

16. The method according to claim 10, wherein the new hoisting machine comprises one motor common to the first and second traction sheave, which traction sheaves are in connection with the motor via a belt gear separate to each traction sheave for moving the first suspension roping and the second suspension roping.

17. The method according to claim 10, wherein the old suspension roping and hoisting machine are removed, and a new hoisting machine is placed in the proximity of the bottom end of the path of movement of the elevator car, said method further comprising the steps of:
arranging the first suspension roping and the second suspension roping to travel on vertical planes parallel to each other;
arranging the first suspension roping to form a loop around one or more diverting pulleys of the first suspension roping;
arranging the second suspension roping to form a loop around one or more diverting pulleys of the second suspension roping in such a way that said loops are nested, and the diverting pulley of the outer loop is disposed outside the inner loop; and
arranging the suspension ropings (R1, R2) are arranged to pass through the apertures in the floor,
wherein a device configured to exert a vertical force on the elevator car or on the counterweight is arranged to comprise traction roping, which is connected to the elevator car and to the counterweight, and
wherein the hoisting machine is arranged to comprise a mechanism configured to move the traction roping, comprising a rotating device and a rotatable traction device.

18. The method according to claim 14, wherein the traction roping is arranged to comprise one or more belt-like ropes or belts.

19. The method according to claim 10, wherein when modernizing an old elevator the size of the old suspension roping lead-in apertures of the floor between the elevator hoistway and the space above the elevator hoistway is not altered.

20. The method according to claim 10, wherein the first suspension roping and the second suspension roping are each arranged to comprise one or more belt-like ropes or belts.
